(19) United States
(12) Patent Application Publication
(10) Pub. No.: US 2025/0344022 A1
(43) Pub. Date: Nov. 6, 2025

(54) DIAPHRAGM ASSEMBLY, SPEAKER AND PORTABLE ELECTRONIC DEVICE

(71) Applicant: Harman International Industries, Incorporated, Stamford, CT (US)

(72) Inventors: Zhenjin ZHU, Shenzhen (CN); Jihui ZENG, Shenzhen (CN); Yuanzhen NIU, Shenzhen (CN); Yadi WANG, Shenzhen (CN)

(73) Assignee: Harman International Industries, Incorporated, Stamford, CT (US)

(21) Appl. No.: 19/269,713

(22) Filed: Jul. 15, 2025

Related U.S. Application Data
(63) Continuation of application No. PCT/CN2023/073687, filed on Jan. 29, 2023.

(51) Int. Cl. H04R 7/10; H04R 1/02; H04R 7/18; H04R 9/02; H04R 9/04; H04R 9/06

(52) U.S. Cl. CPC H04R 7/10; H04R 1/028; H04R 7/18; H04R 9/025; H04R 9/045; H04R 9/06; H04R 2400/11; H04R 2499/15

(57) ABSTRACT

A diaphragm assembly, speaker and portable electronic device are provided. The diaphragm assembly includes a diaphragm body and a dome body. The diaphragm body includes an outer connection portion, an inner diaphragm portion and a folding ring portion which is between and is connected to the outer connection portion and the inner diaphragm portion. The dome body is attached to the inner diaphragm portion of the diaphragm body. The inner diaphragm portion has a center opening so that the inner diaphragm portion is attached to the dome body at a peripheral portion of the dome body.

### CROSS-REFERENCE TO RELATED APPLICATIONS

This application is a continuation of International Application No. PCT/CN2023/073687, filed on Jan. 29, 2023. The disclosures of the above applications are incorporated herein by reference.

### FIELD

The present disclosure relates to a diaphragm assembly for a speaker and a speaker comprising a diaphragm assembly, and particularly to a diaphragm assembly for a micro speaker and a micro speaker comprising a diaphragm assembly. The present disclosure also relates to a portable electronic device comprising a speaker or a micro speaker.

### BACKGROUND

The statements in this section merely provide background information related to the present disclosure and may not constitute prior art.

A speaker or a micro speaker is an important component of a portable electronic device, such as a laptop, a tablet, a pad or a mobile phone. With the development trend of integration and thinness of the portable electronic device, the requirements for the speaker or micro speaker of the electronic device are getting higher and higher. For example, the speaker or micro speaker may need to meet the following requirements while being thin and light: an audio output with higher sensitivity, a high frequency extension, a flat frequency response curve, a large bearing power, a good dive and bass effect, a large displacement and a low distortion.

At present, an existing conventional speaker or micro speaker cannot meet all of the above requirements. For example, a conventional speaker or micro speaker does not meet the requirement for a high frequency extension (greater than 20 kHz). In addition, a conventional speaker or micro speaker does not have a diaphragm or dome body that is rigid or strong enough to prevent a wobble and splitting vibration, especially when the speaker or micro speaker is operating at a high frequency.

Therefore, there is a need for a speaker or micro speaker that can meet the above requirements, especially the requirement for a high frequency extension (larger than 20 kHz).

### SUMMARY

This section provides a general summary of the disclosure and is not a comprehensive disclosure of its full scope or all of its features.

According to one aspect of the disclosure, a diaphragm assembly for a speaker is provided that includes a diaphragm body and a dome body. The diaphragm body includes an outer connection portion, an inner diaphragm portion and a folding ring portion therebetween. The dome body is attached to the inner diaphragm portion of the diaphragm body. The inner diaphragm portion has a center opening so that the inner diaphragm portion is attached to the dome body at a peripheral portion of the dome body.

According to another aspect of the disclosure, a speaker is provided that includes a magnet assembly, a diaphragm assembly, and a voice coil. The magnet assembly defines a magnetic gap. The diaphragm assembly and the outer connection portion of the diaphragm assembly are fixed relative to the magnet assembly. The voice coil is connected to the diaphragm assembly. The voice coil has a portion that is suspended in the magnetic gap.

According to still another aspect of the disclosure, a portable electronic device is provided including one or more speakers as defined above.

Others systems, method, features and advantages of the disclosure will be, or will become, apparent to one with skill in the art upon examination of the following figures and detailed description. It is intended that all such additional systems, methods, features and advantages be included within this description, be within the scope of the disclosure, and be protected by the following claims.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

The present disclosure can be better understood with reference to the following drawings and description. The components in the drawings are not necessarily to scale, instead, emphasis should be placed upon the principles illustrated by the disclosure. Moreover, in the figures, like reference numerals designate like parts throughout the drawings.

FIG. 1A is a cross-sectional view of a speaker according to one or more configurations of the present disclosure;

FIG. 1B is an exploded view of the speaker of FIG. 1A;

FIG. 2A is a cross-sectional view of a diaphragm assembly of the speaker of FIG. 1A;

FIG. 2B is a top view of the diaphragm assembly;

FIG. 2C is an exploded view of the diaphragm assembly;

FIG. 2D is an enlarged view of the diaphragm assembly circled in FIG. 2A

FIG. 3 is a cross-sectional view of another diaphragm assembly according to one or more configurations of the present disclosure;

FIG. 4 is a cross-sectional view of another diaphragm assembly according to one or more configurations of the present disclosure; and

FIG. 5 is a diagram showing comparison between a frequency response curve of a conventional speaker and a frequency response curve of a speaker according to one or more configurations of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

Hereinafter, one or more configurations of the present disclosure will be described in more detail with reference to the accompanying drawings.

As used herein, the singular forms “a”, “an” and “the” are intended to include the plural forms as well, unless the context clearly indicates otherwise. The terms “comprises”, “comprising”, “includes” and/or “including”, as used herein, specify the presence of stated features, integers, steps, operations, elements, and/or components, but do not preclude the presence or addition of one or more other features, integers, steps, operations, elements, components, and/or combinations thereof. As used herein, the term “and/or” and the symbol “/” are meant to include any and all combinations of one or more of the associated listed items. Additionally, while the terms first, second etc. may be used herein to describe various elements, components, steps or calculations, these elements, components, steps or calculations should not be limited by these terms, rather these terms are only used to distinguish one element, component, step or calculation from another. For example, a first component could be termed a second component, similarly a first calculation could be termed a second calculation; similarly a first step could be termed a second step; all without departing from the scope of this disclosure.

As used herein, the term “axis” means a central axis passing through the speaker or the diaphragm assembly, the term “axial direction” means a direction along the axis. The term “inner portion” means the portion is relatively closer to the axis and the term “outer portion” means the portion is relatively away from the axis.

To clarify the use in the pending claims and to hereby provide notice to the public, the phrases “at least one of <A>, <B>, . . . and <N>” or “at least one of <A>, <B>, . . . <N>, or combinations thereof” are defined by the Applicant in the broadest sense, superseding any other implied definitions here before or hereinafter unless expressly asserted by the Applicant to the contrary, to mean one or more elements selected from the group comprising A, B, . . . and N, that is to say, any combination of one or more of the elements A, B, . . . or N including any one element alone or in combination with one or more of the other elements which may also include, in combination, additional elements not listed.

The disclosure provides a speaker or a micro speaker as well as a diaphragm assembly for the speaker that can provide a high frequency extension (>20 kHz) and have a diaphragm or dome body that is rigid or strong enough to inhibit a wobble and splitting vibration, especially when the speaker or micro speaker is operating at a high frequency.

The present disclosure discloses that it may be challenging for conventional micro speakers to achieve a high frequency extension (>20 kHz) mainly for the following reasons: (1) the energy or momentum is not transferred rapidly enough from the diaphragm body to the dome body due to the flexible material at the center portion of the inner diaphragm portion; and (2) the dome body is not rigid or strong enough so that a wobble and splitting vibration may occur when operating at a high frequency.

According to one or more configurations of the present disclosure, the diaphragm assembly comprises a diaphragm body and a dome body. The diaphragm body comprises an outer connection portion, an inner diaphragm portion and a folding ring portion therebetween. The dome body is attached to the inner diaphragm portion of the diaphragm body. The inner diaphragm portion has a center opening so that the inner diaphragm portion is attached to the dome body at a peripheral portion of the dome body. According to one or more configurations of the present disclosure, the center opening of the inner diaphragm portion has a shape similar to that of the dome body and has an area of 50%-80% of that of the dome body.

In one or more configurations of the present disclosure, with the inner diaphragm portion of the diaphragm body being attached to the dome body only at a peripheral portion of the dome body, the energy or momentum from the diaphragm body can be transferred rapidly to the dome body. The rapid transferring of the energy or momentum from the diaphragm body to the dome body can facilitate a high frequency performance or a high frequency extension (>20 kHz) of the speaker or micro speaker. The present disclosure discloses that the inner diaphragm portion having a center opening of 50%-80% area of that of the dome body may be advantageous in facilitating a high frequency performance or a high frequency extension (>20 kHz).

According to one or more configurations of the present disclosure, the dome body of the diaphragm assembly comprises a lamination structure comprising a plurality of metal foil layers and a plurality of foam layers, wherein the metal layers and the foam layers are alternately arranged such that each foam layer is sandwiched between two adjacent metal layers. According to one or more further configurations of the present disclosure, the lamination structure comprises three metal layers and two foam layers. Such a lamination structure of the dome body can improve the strength of the dome body, thereby facilitating a high frequency performance or a high frequency extension (>20 kHz) of the speaker.

According to one or more further configurations of the present disclosure, the plurality of metal layers of the lamination structure comprises at least one intermediate metal layer, each of which is sandwiched between two adjacent foam layers, the intermediate metal layer being formed with through holes. With the through holes in the intermediate metal layer, the metal layers and the foam layers can be better bonded together, resulting in a dome body having a further improved strength, thereby facilitating a high frequency performance or a high frequency extension (>20 kHz) of the speaker.

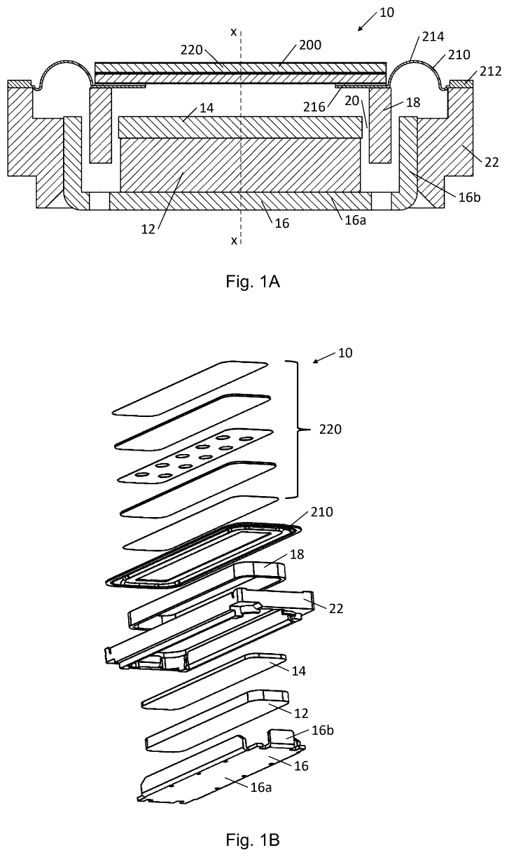

FIGS. 1A-1B show a speaker 10 according to one or more configurations of the present disclosure, wherein FIG. 1A shows a sectional view of a speaker 10 and FIG. 1B shows an exploded view of the speaker 10. As shown in FIGS. 1A-1B, the speaker 10 comprises an axis x, a magnet assembly, a frame 22, a diaphragm assembly 200 and a voice coil 18. The magnet assembly comprises a magnet 12, a top plate 14, a yoke 16 and a magnetic gap 20 formed between the top plate 14 and the yoke 16. The yoke 16 has a yoke base 16a and side walls 16b extending from the yoke base 16a, defining a space for receiving the magnet 12 and the top plate 14 therein. The magnet assembly is arranged so that the top plate 14 and the yoke 16 direct and concentrate the magnetic flux from the magnet 12 to and through the magnetic gap 20. The frame 22 is fixedly coupled to the magnet assembly or the yoke 16 of the magnet assembly. The diaphragm assembly 200 comprises a diaphragm body 210 and a dome body 220. The diaphragm body 210 comprises an outer connection portion 212, a folding ring portion 214 and an inner diaphragm portion 216. The folding ring portion 214 is between the outer connection portion 212 and the inner diaphragm portion 216 and connects the outer connection portion 212 and the inner diaphragm portion 216 together, forming an integral diaphragm body 210. The outer connection portion is fixedly coupled to the frame 22, and is thus fixed relative to the magnet assembly.

The voice coil 18 is connected to the diaphragm assembly 200 and thus moves together with the diaphragm assembly 200. The voice coil 18 has a portion that is suspended in the magnetic gap 20. In one or more configurations shown in FIGS. 1A-1B, the voice coil 18 is connected at its upper end to the inner diaphragm portion 216 of the diaphragm assembly 200 and has a lower portion suspended in the magnetic gap 20. During operation, an audio signal is transmitted to the voice coil 18 via lead wires (not shown). The voice coil 18 vibrates in the magnetic gap 20 in response to the audio signal passing through the voice coil 18 in the magnetic gap 20, causing the diaphragm assembly 200 connected to the voice coil 18 to vibrate to emit sound.

FIGS. 1A-1B show specific structures of the magnet assembly and the frame 22 according to one or more configurations of the present disclosure. However, the present disclosure is not limited thereto. In one or more other configurations of the present disclosure, the magnet assembly may have any suitable structure as long as the magnet assembly can define a magnetic gap for the voice coil to be suspended therein and can direct and concentrate the magnetic flux from the magnet to and through the magnetic gap. In one or more further configurations of the present disclosure, the frame may have any suitable structure as long as it can support the diaphragm assembly. In one or more further configurations of the present disclosure, the frame 22 may be omitted and the diaphragm assembly, i.e., the outer connection portion 212 of the diaphragm body 210, may be directly connected to the magnet assembly.

FIGS. 1A-1B show one or more configurations of the speaker 10 having a substantially rectangular shape. The present disclosure is not limited thereto and may have any suitable shape, such as a square shape, a circular shape or an oblong shape. The speaker 10 as shown in FIGS. 1A-1B is a micro speaker. According to one or more configurations of the present disclosure, the speaker 10 may be a micro speaker of a substantially rectangular shape, having a size of 45*13 mm-45*15 mm, 34 mm*11 mm or 32 mm*9 mm. The speaker 10 may have a thickness of 2-4 mm. According to one or more further configurations of the present disclosure, the speaker 10 may be a speaker or a micro speaker having any suitable size. According to one or more configurations of the present disclosure, the speaker 10 may be a micro speaker for a portable electronic device, such as a laptop, a tablet, a pad or a mobile phone.

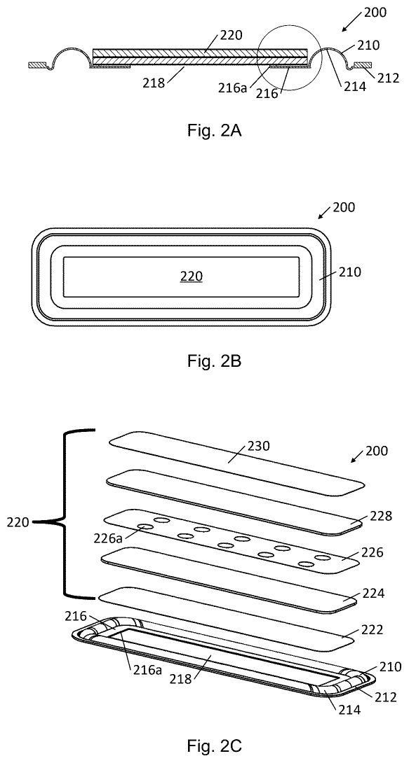

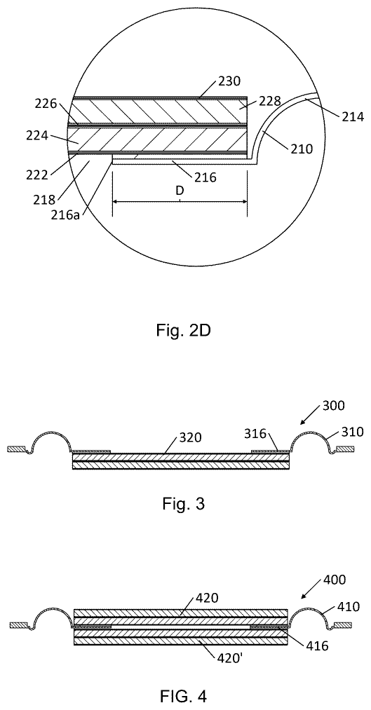

FIGS. 2A-2D show a diaphragm assembly 200 according to one or more configurations of the present disclosure, wherein FIG. 2A shows a sectional view of the diaphragm assembly 200, FIG. 2B shows a top view of the diaphragm assembly 200, FIG. 2C shows an exploded view of the diaphragm assembly 200 and FIG. 2D is an enlarged view of a circled portion of FIG. 2A.

As shown, the diaphragm assembly 200 comprises a diaphragm body 210 and a dome body 220. The diaphragm body 210 comprises an outer connection portion 212, an inner diaphragm portion or body 216 and a folding ring portion 214. The folding ring portion 214 is between the outer connection portion 212 and the inner diaphragm portion 216 and connects the outer connection portion 212 and the inner diaphragm portion 216 together, forming an integral diaphragm body 210. The outer connection portion is adapted to be fixedly coupled to a fixed structure of the speaker. The inner diaphragm portion 216 has an inner peripheral edge 216a which defines a center opening 218. The inner diaphragm portion 216 has a substantially constant dimension D along its periphery, such that the center opening 218 has a smaller but similar shape to the dome body 220. In one or more configurations, the center opening 218 of the inner diaphragm portion 216 has an area of 50%-80% of that of the dome body. As compared to a conventional diaphragm assembly where there is no center opening in the inner diaphragm portion and the inner diaphragm portion is bonded to the dome body over substantially an entire surface of the dome body 220. In the one or more configurations of the present disclosure, the energy or momentum from the diaphragm body can be transferred to the dome body more rapidly and the resonant frequency of the diaphragm assembly can become higher, facilitating a high frequency performance or a high frequency extension (>20 kHz) of the speaker or micro speaker.

FIGS. 2A-2D show a specific structure of the inner diaphragm portion. However, the present disclosure is not limited thereto. In one or more other configurations of the present disclosure, the inner diaphragm portion may have any suitable shape, as long as it has a center opening of a suitable size and shape so that it is attached or bonded to the dome body only at a peripheral portion of the dome body and the energy or momentum from the diaphragm body can be transferred rapidly to the dome body.

The dome body 220 of the diaphragm assembly 200 comprises a lamination structure comprising a plurality of metal layers and a plurality of foam layers. As shown, the lamination structure comprises five layers that are bonded together, namely three aluminum foil layers 222, 226, 230 and two foam layers 224, 228. The aluminum foil layers 222, 226, 230 and two foam layers 224, 228 are alternately arranged such that each foam layer is sandwiched between two adjacent aluminum foil layers, with the aluminum foil layers 222, 230 forming outer surfaces of the dome body 220. Particularly, the foam layer 224 is sandwiched between the aluminum foil layers 222, 226 and the foam layer 228 is sandwiched between the aluminum foil layers 226, 230. Such a lamination structure of the dome body 220 can improve the strength of the dome body 220, thereby facilitating a high frequency performance or a high frequency extension (>20 kHz) of the speaker.

According to one or more configurations of the present disclosure, the intermediate aluminum foil layer 226 is provided with a plurality of evenly distributed through holes 226a. With the through holes 226a provided in the intermediate aluminum foil layer 226, excess adhesive between the intermediate aluminum foil layer 226 and the foam layers 224, 228 can flow into the through holes 226a when bonding the layers to form the lamination structure, resulting in a better bonding between the layers in the lamination structure and thus an improved strength of the dome body 220.

According to one or more configurations of the present disclosure, the layers 222, 226, 230 are aluminum foil layers and the layers 224, 228 are PMI (polymethacrylimide) foam layers. The present disclosure is not limited thereto, and the layers 222, 226, 230 may be foil layers of other suitable metal and the layers 224, 228 may be layers of other suitable foams. In one or more configurations as shown in FIGS. 2A-2D, the dome body 220 comprises five layers, i.e., three aluminum foil layers 222, 226, 230 and two foam layers 224, 228, with one intermediate aluminum foil layer 226 being sandwiched between two foam layers 224, 228. The present disclosure is not limited thereto. According to one or more other configurations of the present disclosure, the dome body 220 may comprise more than five layers, such as seven layers. In one or more configurations, there may be more than one intermediate aluminum foil layer. For example, there may be two intermediate aluminum foil layers, each being sandwiched between two foam layers. In one or more configurations as shown in FIGS. 2A-2D, the intermediate aluminum foil layer is provided with a plurality of through holes. The present disclosure is not limited thereto. According to one or more other configurations of the present disclosure, the through holes in the intermediate aluminum foil layer may be omitted.

As compared to a conventional dome body which may have a lamination structure of three layers, with one foam layer being sandwiched between two metal foil layers, the dome body of the present disclosure having a lamination structure of five or more layers has an improved strength. In one or more configurations of the present disclosure, the foam layers of the dome body have a reduced thickness so that the dome body of the present disclosure can have an improved strength with a same or similar overall thickness or weight as compared to a conventional dome body. In one or more configurations of the present disclosure, the intermediate aluminum foil layer has evenly distributed through holes that can improve the bonding between the layers of the dome body, and thus can further improve the strength of the dome body.

The diaphragm assembly 200 as shown in FIGS. 1A-1B, 2A-2D can achieve a most favorable high frequency performance or a high frequency extension (>20 kHz) of the speaker or micro speaker due to the combination of: the inner diaphragm portion 216 of the diaphragm assembly 200 having a center opening 218, the dome body 220 having a lamination structure of five or more layers with the intermediate aluminum foil layer 226 having evenly distributed through holes 226a.

FIG. 3 is a cross-sectional view showing a diaphragm assembly 300 according to one or more further configurations of the present disclosure. The diaphragm assembly 300 comprises a diaphragm body 310 and a dome body 320. Unlike the one or more configurations shown in FIGS. 1A-1B, 2A-2D where the dome body 220 is provided on the inner diaphragm body 216 and is attached to an upper surface of the inner diaphragm body 216 of the diaphragm assembly 200, in the one or more configurations shown in FIG. 3, the dome body 320 is provided under the inner diaphragm body 316 and is attached to a lower surface of the inner diaphragm body 316 of the diaphragm body 310. Except for the aforementioned difference, the diaphragm assembly 300 is similar or the same as the diaphragm assembly 200 shown in FIGS. 1A-1B, 2A-2D, and a detailed description thereof is omitted.

FIG. 4 is a cross-sectional view showing a diaphragm assembly 400 according to one or more further configurations of the present disclosure. The diaphragm assembly 400 comprises a diaphragm body 410 and a dome body 420. Unlike the one or more configurations shown in FIGS. 1A-1B, 2A-2D where the dome body 220 is provided on the inner diaphragm body 216 and attached to an upper surface of the inner diaphragm body 216 of the diaphragm assembly 200, in the one or more configurations shown in FIG. 4, there are two lamination structures or dome bodies 420, 420′, with one being provided on the inner diaphragm body 416 and being attached to an upper surface of the inner diaphragm body 416, and another one being provided under the inner diaphragm body 416 and being attached to a lower surface of the inner diaphragm body 416. That is, the inner diaphragm body 416 is sandwiched between the two lamination structures or dome bodies 420, 420′. Except for the aforementioned difference, the diaphragm assembly 400 is similar or the same as the diaphragm assembly 200 shown in FIGS. 1A-1B, 2A-2D, and a detailed description thereof is omitted.

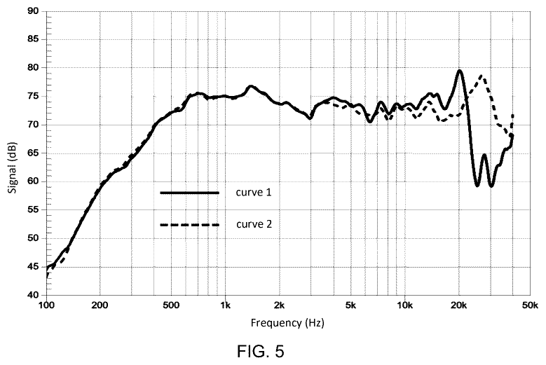

FIG. 5 is a diagram showing a comparison between a frequency response curve 1 and a frequency response curve 2. Curve 1 is a frequency response curve as measured from a conventional micro speaker in which there is no center opening in the inner diaphragm portion and the inner diaphragm portion is bonded to the dome body over substantially an entire surface of the dome body, and the dome body may have a lamination structure of three layers, in which a foam layer is sandwiched between two metal foil layers. Curve 2 is a frequency response curve as measured from a speaker or a micro speaker according to the one or more configurations shown in FIGS. 1A-1B, 2A-2D. As clearly shown in FIG. 5, the curve 2 has a flatter frequency response curve in the frequency range from 8 k to 20 k Hz, and has a much better frequency response curve in the frequency range of above 20 k Hz.

According to one or more configurations of the present disclosure, the present disclosure can be implemented as follows.
Item 1: A diaphragm assembly for a speaker including a diaphragm body and a dome body. The diaphragm body, comprising an outer connection portion, an inner diaphragm portion and a folding ring portion therebetween. The dome body attached to the inner diaphragm portion of the diaphragm body. The inner diaphragm portion has a center opening so that the inner diaphragm portion is attached to the dome body at a peripheral portion of the dome body.
Item 2: The diaphragm assembly according to Item 1, wherein the dome body comprises a lamination structure comprising a plurality of metal layers and a plurality of foam layers, the metal layers and the foam layers being alternately arranged so that each foam layer is sandwiched between two adjacent metal layers.
Item 3: The diaphragm assembly according to any of Items 1-2, wherein the plurality of metal layers comprises at least one intermediate metal layer, each of which is sandwiched between two adjacent foam layers, the at least one intermediate metal layer being formed with through holes.
Item 4: The diaphragm assembly according to any of Items 1-3, wherein the lamination structure comprises three metal layers and two foam layers.
Item 5: The diaphragm assembly according to any of Items 1-4, wherein the lamination structure is attached to an upper surface or a lower surface of the inner diaphragm portion.
Item 6: The diaphragm assembly according to any of Items 1-5, wherein the dome body comprises two lamination structures, and the inner diaphragm portion is sandwiched between and attached to the two lamination structures.
Item 7: The diaphragm assembly according to any of Items 1-6, wherein the diaphragm assembly is of a rectangular shape, a square shape, a circular shape or an oblong shape.
Item 8: The diaphragm assembly according to any of Items 1-7, wherein the dome body is of a planar shape.
Item 9: The diaphragm assembly according to any of Items 1-8, wherein the center opening of the inner diaphragm portion has an area of 50%-80% of that of the dome body.
Item 10: The diaphragm assembly according to any of Items 1-9, wherein the metal layers are aluminum foil layers and the foam layers are PMI foam layers.
Item 11: A speaker including a magnet assembly, a diaphragm body, and a voice coil. The magnet assembly defines a magnetic gap. The diaphragm assembly according to any of Items 1-10, the outer connection portion of the diaphragm assembly is fixed relative to the magnet assembly. The voice coil is connected to the diaphragm assembly. The voice coil has a portion that is suspended in the magnetic gap.
Item 12: The speaker according to Item 11, wherein the speaker is a micro speaker.
Item 13: The speaker according to any of Items 11-12, wherein the speaker further comprises a frame attached to the magnet assembly, and the outer connection portion of the diaphragm assembly is fixedly connected to the frame.
Item 14: A portable electronic device, comprising one or more speakers according to any of Items 11-13.
Item 15: The portable electronic device according to Item 14, wherein the portable electronic device is a laptop, a tablet, a pad or a mobile phone.

Systems and methods have been described in general terms as an aid to understanding details of the disclosure. In some instances, well-known structures, materials, and/or operations have not been specifically shown or described in detail to prevent obscuring aspects of the disclosure. In other instances, specific details have been given in order to provide a thorough understanding of the disclosure. One skilled in the relevant art will recognize that the disclosure may be embodied in other specific forms, for example to adapt to a particular system or apparatus or situation or material or component, without departing from the spirit or essential characteristics thereof. Therefore, the disclosures and descriptions herein are intended to be illustrative, but not limiting, of the scope of the disclosure. Accordingly, the disclosure is not to be restricted except in light of the attached claims and their equivalents.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

In this application, the term “controller” and/or “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components (e.g., op amp circuit integrator as part of the heat flux data module) that provide the described functionality; or a combination of some or all of the above, such as in a system-on-chip.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A diaphragm assembly for a speaker, comprising:
a diaphragm body comprising an outer connection portion, an inner diaphragm portion and a folding ring portion therebetween; and
a dome body attached to the inner diaphragm portion of the diaphragm body,
wherein the inner diaphragm portion has a center opening so that the inner diaphragm portion is attached to the dome body at a peripheral portion of the dome body.

2. The diaphragm assembly according to claim 1, wherein the dome body comprises a lamination structure comprising a plurality of metal layers and a plurality of foam layers, the metal layers and the foam layers being alternately arranged so that each foam layer is sandwiched between two adjacent metal layers.

3. The diaphragm assembly according to claim 2, wherein the plurality of metal layers comprises at least one intermediate metal layer, each intermediate metal layer sandwiched between two adjacent foam layers, each intermediate metal layer being formed with through holes.

4. The diaphragm assembly according to claim 2, wherein the lamination structure comprises three metal layers and two foam layers.

5. The diaphragm assembly according to claim 2, wherein the lamination structure is attached to an upper surface or a lower surface of the inner diaphragm portion.

6. The diaphragm assembly according to claim 2, wherein the dome body comprises two lamination structures, and the inner diaphragm portion is sandwiched between and attached to the two lamination structures.

7. The diaphragm assembly according to claim 1, wherein the diaphragm assembly is of a rectangular shape, a square shape, a circular shape or an oblong shape.

8. The diaphragm assembly according to claim 1, wherein the dome body is of a planar shape.

9. The diaphragm assembly according to claim 1, wherein the center opening of the inner diaphragm portion has an area of 50%-80% of that of the dome body.

10. The diaphragm assembly according to claim 2, wherein the metal layers are aluminum foil layers and the foam layers are polymethacrylimide (PMI) foam layers.

11. A speaker, comprising:
a magnet assembly defining a magnetic gap;
a diaphragm assembly according to claim 1, the outer connection portion of the diaphragm assembly is fixed relative to the magnet assembly; and
a voice coil connected to the diaphragm assembly, the voice coil having a portion that is suspended in the magnetic gap.

12. The speaker according to claim 11, wherein the speaker is a micro speaker.

13. The speaker according to claim 11, further comprising a frame attached to the magnet assembly, the outer connection portion of the diaphragm assembly is fixedly connected to the frame.

14. The speaker according to claim 11, wherein the dome body comprises a lamination structure comprising a plurality of metal layers and a plurality of foam layers, the metal layers and the foam layers being alternately arranged so that each foam layer is sandwiched between two adjacent metal layers.

15. The speaker according to claim 14, wherein the plurality of metal layers comprises at least one intermediate metal layer, each intermediate metal layer sandwiched between two adjacent foam layers, each intermediate metal layer being formed with through holes.

16. The speaker according to claim 14, wherein the lamination structure comprises three metal layers and two foam layers.

17. The speaker according to claim 14, wherein the lamination structure is attached to an upper surface or a lower surface of the inner diaphragm portion.

18. The speaker according to claim 14, wherein the dome body comprises two lamination structures, and the inner diaphragm portion is sandwiched between and attached to the two lamination structures.

19. A portable electronic device, comprising one or more speakers according to claim 11.

20. The portable electronic device according to claim 19, wherein the portable electronic device is a laptop, a tablet, a pad or a mobile phone.
